(19) United States
(12) Patent Application Publication
(10) Pub. No.: US 2007/0114295 A1
(43) Pub. Date: May 24, 2007

(54) Wireless thermostat

(75) Inventor: Patrick A. Jenkins, Townsend, TN (US)

Correspondence Address: REINHART BOERNER VAN DEUREN P.C., 2215 PERRYGREEN WAY, ROCKFORD, IL, 61107, US

(73) Assignee: Robertshaw Controls Company, Richmond, VA (US)

(21) Appl. No.: 11/287,116

(22) Filed: Nov. 22, 2005

(51) Int. Cl. G05D 23/12; G05D 23/00

(52) U.S. Cl. 236/51; 236/1 C

(57) ABSTRACT

A system for remotely controlling an ambient temperature in a building is provided. The system comprises a thermostat, a computing device, and a thin client. The thermostat has one or more settings and is equipped for wireless communication. The computing device is equipped for wireless communication with the thermostat. The thin client device is remotely located from the thermostat and operatively coupled to the computing device through a wide area network. The thin client device permits manipulation of the one or more settings which are wirelessly communicated from the computing device to the thermostat such that the ambient temperature of the building is remotely controlled.

### FIELD OF THE INVENTION

This invention generally relates to heating, ventilation, and air conditioning systems and, more particularly, to thermostats employed in those systems.

### BACKGROUND OF THE INVENTION

Occupants of dwellings and commercial structures have long benefited from the inclusion of a heating, ventilating, and air conditioning (HVAC) system that regulates the temperature and humidity within the dwelling or structure. Traditionally, the thermostat that controlled this temperature regulating equipment was a fairly simple electromechanical device that was simply wired to a heating device and/or to a cooling device. Once installed, the user need only move a selector switch between heating and cooling to designate which equipment was desired to be operated, move a selector switch between run and auto for a fan control, and rotate a dial to a desired set point temperature. No other user interface to the thermostat was needed or available.

Advances in control electronics have allowed the development of new, digital thermostats that may be programmed by a user to control the heating and cooling equipment in a much more energy efficient manner than the older electromechanical devices. These modem digital thermostats allow programming that can automatically set back the heat, for example, during periods when the dwelling or structure is not occupied, and can turn up the heat just prior to and during periods of occupation of the dwelling or structure. Indeed, many such digital thermostats allow for different programming options during different days of the week. For example, such a digital thermostat may provide for one programmed operation during the week and a different programmed operation on the weekend, to accommodate the different usage patterns of the occupants of that particular dwelling or structure.

Unfortunately, setting or programming these new digital thermostats often requires that a user be physically located in close proximity (e.g., within arm's reach) to the thermostat. As such, the user can only adjust the thermostat settings and programming instructions if the user is inside the dwelling or structure housing the thermostat. To overcome this user proximity requirement, digital thermostats that are “hard wired” to a personal computer or a local area network (LAN) using conventional cabling such as, for example, an unshielded type twisted pair cable (e.g., a Cat 5 cable, a Cat 5e cable, a Cat 6 cable, and the like) have been made available.

In such a system, the personal computer or the LAN are operatively coupled to a web server in a wide area network (WAN) such as the Internet. The web server is accessible via a “thin client” computing device that is also coupled to the WAN yet remotely located with respect to the thermostat. When the web server is accessed using the thin client computing device, the web server generates a user interface such as, for example, a graphic user interface for display on the thin client computing device. The graphic user interface displays or makes available the possible settings, programming options, and features of the digital thermostat. Ideally, if the web server is maintained and operated by the manufacturer of the thermostat, the graphic user interface is precisely tailored to resemble the look and functionality of the remotely located thermostat.

With the thermostat represented on the thin client by the graphic user interface, the thermostat user is permitted to input, update, and/or modify the possible settings, programming options, and features that are normally only accessible through direct physical contact. After the desired inputs, updates, and modifications have been made, the information is relayed back to the thermostat and the HVAC system. Resultantly, the thermostat user is able to remotely control a temperature of an environment within the dwelling or structure.

While the above-noted solution permits the thermostat to be controlled from a remote location via the thin client, the solution has at least one significant drawback. Since the personal computer or the LAN is hard wired to the thermostat by the cable (i.e., Cat 5), the solution is only convenient where the structure or dwelling already includes that type of cabling or will include the appropriate cabling when built. In the more frequently encountered situation where the building fails to include the requisite cable or cable type, installing the needed cabling may not be economically feasible, structurally possible, and/or practical.

Therefore, an improved system permitting remote access to a thermostat and control of an HVAC system, without the need for installation of cable within the dwelling, would be desirable. The invention provides such a system. These and other advantages of the invention, as well as additional inventive features, will be apparent from the description of the invention provided herein.

### BRIEF SUMMARY OF THE INVENTION

In view of the above, the present invention provides a new and improved digital thermostat that overcomes one or more of the problems currently existing in the art. More particularly, the present invention provides a new and improved digital thermostat that may be remotely accessed without the need for hard wiring to be installed or included within the dwelling. Even more particularly, the present invention provides a new and improved digital thermostat that may be wirelessly accessed to allow remote programming and operation of the heating, ventilation and air conditioning (HVAC) system within a dwelling.

In one aspect, the invention provides a system for remotely controlling an ambient temperature in a structure. The system comprises a thermostat, a computing device, and a thin client. The thermostat has one or more settings and is equipped for wireless communication. The computing device is equipped for wireless communication with the thermostat. The thin client device is remotely located from the thermostat and operatively coupled to the computing device through a wide area network (WAN). The thin client device permits manipulation of the one or more settings, which are wirelessly communicated from the computing device to the thermostat, such that the ambient temperature of the building is remotely controlled.

In another aspect, the invention provides a system for remotely controlling an ambient temperature in a residential dwelling. The system comprises a computing device and a thermostat. The computing device establishes a wireless local area network (LAN) within the residential dwelling. The thermostat has one or more settings for controlling a temperature adjustment device and is equipped for wireless communication via the wireless LAN with at least the computing device. The computing device displays a user interface to allow manipulation of the one or more settings. The computing device communicates the one or more settings to the thermostat via the wireless LAN.

In yet another aspect, the invention provides a system for remotely controlling an ambient temperature in a structure. The system comprises a digital thermostat and a wireless local area network (LAN). The digital thermostat has one or more settings for controlling a temperature adjustment device and is equipped for wireless communication. The wireless LAN includes a computing device accessible thereon. The digital thermostat wirelessly communicates with the computing device via the wireless LAN to allow configuration of the one or more settings from the computing device.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a simplified schematic view of an exemplary embodiment of a system for remotely controlling an ambient temperature in a building constructed in accordance with the teachings of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

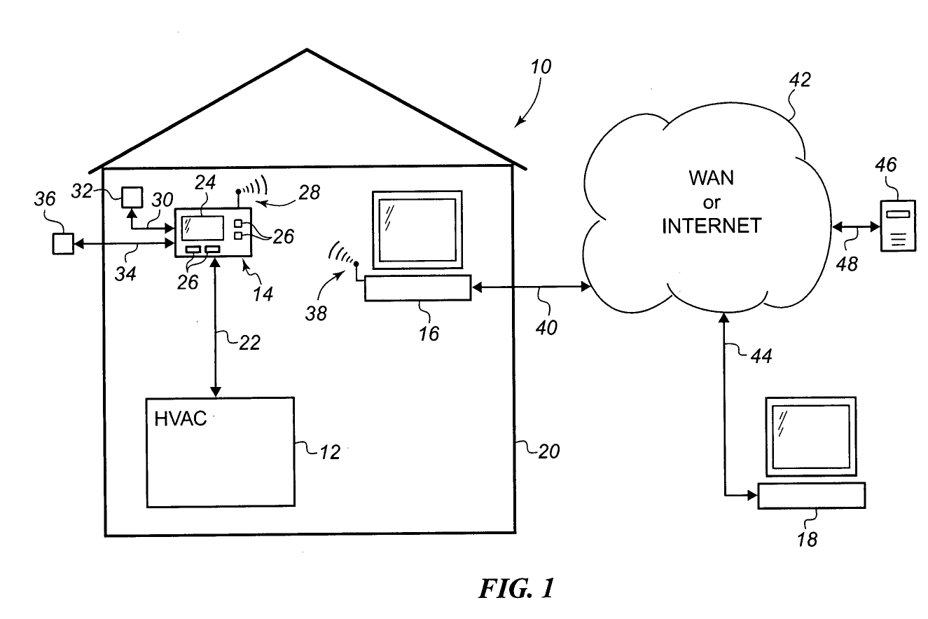

Referring to FIG. 1, a system 10 for remotely controlling an ambient temperature in a structure or dwelling is illustrated. As will be explained more fully below, the system 10 advantageously permits remote access to a thermostat that controls a heating, ventilating, and air conditioning (HVAC) system without the need for cables or wires in a structure or dwelling. The system 10 includes an HVAC system 12, a thermostat 14, and a device 16 to connect to a wide area network (WAN) such as the Internet 42. The device 16 may be a computing device such as a home or portable personal computer (PC), a wireless router, an Internet appliance, etc. Advantageously, the system 10 of the present invention may allow access to and operation of the thermostat programming and information via a thin client device 18.

The HVAC system 12, the thermostat 14, and the computing device 16 are typically found within a structure 20 such as, for example, a commercial building or a residential dwelling. The HVAC system 12 operates to regulate the temperature and possibly the humidity within the structure 20. As illustrated by communication arrow 22, the HVAC system 12 is able to transmit information and control signals back and forth with the thermostat 14. The communication that is represented by the communication arrow 22 (as well as communication arrows 30, 34, 40, 44, 48 as will be discussed more fully below) may be wired or wireless, including communication via satellite, and the like.

The thermostat 14 is preferably a digital thermostat that includes a display 24, one or more actuating members 26, and wireless communication equipment 28. The thermostat 14 is used to receive and store one or more settings that relate to the control of the HVAC system 12. For example, the thermostat 14 is able to receive and store a heat setting (e.g., 68° F.) and a cool setting (e.g., 76° F.). While the ambient temperature in the structure 20 near the thermostat 14 remains between the heat setting and the cool setting, the HVAC sits idle. If the temperature in the structure 20 falls below the heat setting, the heating device in the HVAC system 12 is activated until the ambient temperature in the structure is adequately increased. In contrast, if the temperature in the structure 20 increases above the cool setting, the cooling device in the HVAC system 12 is activated until the ambient temperature in the structure is adequately decreased.

In addition to the basic heating and cooling settings noted above, the new digital thermostats include more advanced settings relating to, for example, a time of the day, a day of the week, a season of the year, and the like. In fact, the thermostat 14 can include a host of other settings that pertain to the operation of the HVAC system, features and functions of the thermostat, and/or operation of the entire system 10. Using these settings, the user of the thermostat 14 is able to “program” the thermostat to operate or remain idle as desired, to conserve energy, to provide a comfortable environment within the structure 20 no matter the time of day and outside temperature, and the like. Other programmatic operation of the thermostat 14 may be provided as is conventional, and does not serve to limit the present invention in any way.

The display 24 on the thermostat 14 displays the one or more settings and features of the thermostat 14 as detailed above. The display 24 is also commonly used to exhibit a variety of other information such as, for example, the present ambient temperature in the structure 20, whether a component in the HVAC system is on or off, whether the fan is on or off, and the like. The amount and type of information that can be illustrated on the display 24 is virtually unlimited. Also, the display 24 is commonly a back lit, liquid crystal display (LCD). However, other well known types of displays are acceptable and can be employed.

The one or more actuating members 26 used on the thermostat 14 can be a button, a knob, a wheel, a scroll bar, a touch pad, soft key, and the like. Such actuating members 26 are conventionally located on the face of the thermostat 14 for easy access and manipulation by the thermostat user. Using one or more of the actuating members 26, the thermostat user is able to set, input, update, change, and/or modify one or more of the settings as noted above. If a desired setting is not presently shown on the display 24, the thermostat user is also able to change the information shown on the display using the actuating members 26. For example, the thermostat user is able to scroll through a list of available settings, features, and functions of the thermostat 14 using the actuating members 26 until the needed or desired setting is shown.

The wireless communication equipment 28 employed by the thermostat 14 can be internal, external, or some combination of the two. As is well known in the art, the wireless communication equipment 28 includes one or more of a receiver, a transmitter, and/or a transceiver, and is employable to permit wireless communication. In other words, the wireless communication equipment permits the thermostat 14 to send and receive (i.e. transmit) data and information through the air without the need for cables, wires, and the like.

In one embodiment, the thermostat 14 is operatively coupled, as depicted by communication arrow 30, to at least one temperature sensor 32 positioned within the structure 20. The thermostat 14 may also be operatively coupled, as shown by communication arrow 34, to at least one sensor 36 that is positioned outside of the structure 20. The sensors 32, 36 can communicate with the thermostat 14 via a wired interface or wirelessly as indicated above and are, in one embodiment, battery-powered. Each of the sensors 32, 36 is adapted to sense and/or read a temperature or other information and relay that information back to the thermostat 14. Based on the received information, the thermostat 14 can take a host of different actions to control the HVAC equipment 12, display information, enter different modes of operation, provide notifications, etc.

In a preferred embodiment of the present invention, the computing device 16 is a personal computer that operates a wireless local area network (LAN). A LAN, which is sometimes referred to as a personal area network (PAN), is generally a wireless computer network that covers a local area such as, for example, a home, an office, etc. The LAN can include one or more computers, one or more web servers, and other computing equipment facilitating communication between the computers and servers and making available system resources, e.g. a printer, etc. Typically, one of the computers 16 in the wireless network provides the communications 40 to the Internet for all of the connected devices.

To facilitate the wireless communication and connectivity within the home network, the computing device 16 also includes wireless communication equipment 38 to permit wireless communication with at least the thermostat 14. Again, the wireless communication equipment 38 includes one or more of a receiver, a transmitter, and/or a transceiver, as well known in that art, and is employable to permit wireless communication. In one embodiment, the wireless communication equipment 38 may be an embedded wireless fidelity (WiFi) card.

The computing device 16 is operatively coupled, as illustrated by communication arrow 40, to a wide area network (WAN) 42, such as the Internet. Through the wireless communication with the computing device 16, the thermostat 14 may also be coupled to the WAN 42. As such, the thermostat 14 may access data from the Internet 42 for display on the display 24, for use in operation of the HVAC equipment 12, for variation in program settings, etc. The thermostat 14 may also receive alerts from web servers 46 coupled 48 to the Internet, such as weather alerts, etc. for display and or use in operation of the HVAC equipment 12.

Also connectable to the Internet 42 via a wired or wireless communication 44 is the thin client device 18. The thin client device 18 is a computing device, such as a personal computer, internet appliance, portable computing device, a pager, a cell phone, a personal digital assistant (PDA), etc. As such, the thin client device 18 is coupled, via the WAN 42, to the computing device 16, the thermostat 14, and/or to a web server 46. Such a web server 46 may be maintained by, for example, the manufacturer or retailer of the thermostat 14. The thin client device 18 may be a hardware device or software that relies on one or more of the data processing, applications, and software of the thermostat 14, the computing device 16, and/or the web server 46 to operate. Even so, the thin client device 18 can provide some data processing, applications, software, and information storage capabilities if desired. However, in the system of the present invention, the computing power of the thin client device 18 is not limiting on the invention. Advantageously, because the thin client 18 may communicate with the thermostat 14 via the WAN and LAN, the thin client device 18 may be remotely located with respect to the thermostat 14 and, in most cases, located entirely outside the structure 20.

The thin client device 18 is adapted to provide an interface that links the thermostat user (who is using or operating the thin client device 18) to the remotely located thermostat 14. The user interface is preferably a graphic or graphical user interface (GUI), as well known in the art. Such a GUI can include one or more menus, drop down boxes, scrollable lists, input windows and graphics, and the like. The GUI can be designed and tailored to mimic or closely resemble the look and functionality of the particular brand, model, and type of thermostat 14 within the system 10. Therefore, the GUI can display and/or make available all of the settings, programming features, and functions (collectively referred to as “settings”) of the thermostat 14.

In one embodiment, the computing device 16, which is located within the structure 20, is also adapted to display the graphic user interface for a thermostat user in addition to the thin client device 18 displaying such information. Therefore, no matter where the thermostat user is located, the user has access to the settings of the thermostat 14. In one embodiment, the user interface or GUI can be, depending on the configuration of the system 10, generated by the personal computing device 16, the thin client device 18 and/or by the web server 46. In the embodiment wherein the thin client device 18 generates the GUI, it may be more accurately characterized as a remote computing device, although for simplicity of description, the term thin client device 18 will be used herein.

In operation in one embodiment of the present invention, the thermostat user directs the web browser of the thin client device 18 to a particular website or other portal to access the settings of the thermostat 14. In an embodiment in which a secure connection is used, the user enters identifying information to “log on” or “log in” to the computing device 16 and/or the web server 46 associated with the system 10. Once authenticated, the thermostat user is provided with the graphical user display that shows and/or makes available all of the settings of the thermostat 14. The thermostat user can simply view the settings or can manipulate them as desired.

If the thermostat user decides to change the one or more of settings, features, and functions, the user simply employs the menus, drop boxes, lists, and input windows on the graphic user interface to input new or updated information. Regardless of the setting that is input or updated, the new or updated information is transmitted from the thin client device 18 to the server 46 and/or to the computing device 16 via the WAN 42. Thereafter, the computing device 16 wirelessly relays the newly acquired information to the thermostat 14. The thermostat 14 thereafter appropriately controls the HVAC system 12 based on the received information.

For example, if a heat setting is to be increased before the thermostat user arrives at the structure 20, the thermostat user selects the heat setting input on the GUI from the thin client 18 and increases the heat setting. Thereafter, the information is relayed though the system 10 and wirelessly transmitted from the computing device 16 to the thermostat 14. The thermostat 14, in turn, instructs the heating device in the HVAC system to heat the structure 20 until the desired temperature is reached. As such, the thermostat user is able to remotely adjust and control the ambient temperature within the structure 20 just as if the thermostat user were standing in front of the thermostat and physically manipulating the actuating members 26.

Additionally, the thermostat 14 can report information back to the thermostat user such that the user can view and respond to that information through the thin client device 18. For example, via the sensors 32, 36, the thermostat 14 can report the local temperature within and without the structure 20 to the thermostat user by transmitting this information wirelessly over the wireless LAN to the computing device 16. The computing device then transmits this information via the WAN to the server 46 and/or to the thin client 18. Additionally, if the HVAC system 12 has suffered a malfunction, the thermostat 14 can relay that information to the thermostat user at the thin client device 18 in the same manner. That information can be packaged, and then sent and received, in the form of an electronic mail (e-mail) message, an audible and visual warning, an alarm signal, visual warnings on the GUI of the thin client device 18, and the like.

As will be recognized by those skilled in the art, the thermostat user can remotely control the operation of the thermostat 14 and the HVAC system 12 from the thin client device 18, without the thermostat 14 and computing device 16 having to be physically connected, no matter how far away from the thermostat and the structure 20 the thermostat user may be at the time. Moreover, since the thermostat 14 is effectively coupled to a WAN 42 such as the Internet, the thermostat is able to access, send and retrieve, and display any of the information that is available on the Internet. As an example, the thermostat 14 can retrieve and display weather related information, the current weather conditions, the weather forecast, precipitation types and amounts, traffic conditions, and the like on display 24. The thennostat 14 may also utilize this information to alter or supplement its programming and/or settings.

Additionally, since the thermostat 14 and the computing device 16 operate via wireless communication, cabling does not need to be installed in the structure 20 for communication to exist between the thermostat 14 and the computing device 16. This lack of any “hard wiring” allows for easy of installation when coupling the computing device 16 and the thermostat 14 within the structure 20. Also, since the settings (which includes features and functions) can be remotely accessed, the thermostat 14 is easy to configure, permits remote monitoring of an ambient temperature within the structure 20 (as well as other conditions), and permits remote energy management. For example, if the user were to go on vacation, but had forgotten to set the thermostat 14 to an energy savings mode, the user could simply log on to the system 10 while on vacation from any Internet ready device and set the thermostat 14 to a vacation mode to conserve energy.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for remotely controlling an ambient temperature in a structure, the system comprising:
a thermostat having one or more settings, the thermostat equipped for wireless communication;
a computing device equipped for wireless communication with the thenmostat; and
a thin client device remotely located from the thermostat and operatively coupled to the computing device through a wide area network (WAN), the thin client device permitting manipulation of the one or more settings which are wirelessly communicated from the computing device to the thenmostat such that the ambient temperature of the building is remotely controlled.

2. The system of claim 1, wherein the thermostat wirelessly transmits information to the computing device, and wherein the computing device relays the information to the thin client device via the WAN.

3. The system of claim 1, wherein the computing device is one of a personal computer and a local area network (LAN) including a web server.

4. The system of claim 1, wherein the thenmostat includes one or more of a wireless transmitter, a wireless receiver, and a wireless transceiver to facilitate the wireless communication.

5. The system of claim 1, wherein the computing device includes one or more of a wireless transmitter, a wireless receiver, and a wireless transceiver to facilitate the wireless communication.

6. The system of claim 1, further comprising a web server operatively coupled to the WAN, and wherein the thin client displays a user interface hosted from the web server to allow manipulation of the one or more settings.

7. The system of claim 6, wherein the user interface is a graphic user interface to facilitate the permitting manipulation of the one more settings.

8. The system of claim 1, wherein the computing device wirelessly transmits weather related information from the WAN to the thermostat, and wherein the thermostat displays the weather related information.

9. The system of claim 1, wherein the thermostat wirelessly transmits alerts to the computing device, and wherein the computing device transmits the alerts to the thin client via the WAN.

10. The system of claim 1, wherein the computing device displays a user interface permitting manipulation of the one or more settings, the computing device wirelessly communicating the one or more settings to the thermostat such that the ambient temperature of the building is controlled remotely from the thermostat.

11. The system of claim 1, wherein the system further comprises a wireless temperature sensor positioned to monitor a temperature remotely from the thermostat, the sensor wirelessly transmitting information relating to the temperature to the thermostat.

12. A system for remotely controlling an ambient temperature in a residential dwelling, the system comprising:
a computing device establishing a wireless local area network (LAN) within the residential dwelling;
a thermostat having one or more settings for controlling a temperature adjustment device, the thermostat equipped for wireless communication via the wireless LAN with at least the computing device; and
wherein the computing device displays a user interface to allow manipulation of the one or more settings; and
wherein the computing device communicates the one or more settings to the thermostat via the wireless LAN.

13. The system of claim 12, further comprising a thin client device remotely located from the thermostat and operatively coupled to the computing device through a wide area network (WAN), the thin client device displaying a user interface to allow manipulation of the one or more settings, wherein the thin client device transmits the at least one or more settings to the computing device via the WAN, and wherein the computing device communicates the one or more settings to the thermostat via the wireless LAN such that the ambient temperature in the residential dwelling is remotely controlled from the thin client device.

14. The system of claim 13, further comprising a web server operatively coupled to the WAN, and wherein the user interface is hosted from the web server.

15. The system of claim 14, wherein the thin client device transmits the at least one or more settings to the web server via the WAN, and wherein the web server transmits the at least one or more settings to the computing device via the WAN, and wherein the computing device communicates the one or more settings to the thermostat via the wireless LAN such that the ambient temperature in the residential dwelling is remotely controlled from the thin client device.

16. The system of claim 12, wherein the computing device is operatively coupled to a wide area network (WAN), and further comprising a web server operatively coupled to the WAN, and wherein the user interface is hosted from the web server.

17. The system of claim 12, wherein the system further comprises a battery-powered sensor adapted to monitor a temperature remote from the thermostat, the battery-powered sensor equipped for wireless communication with the thermostat via the LAN.

18. A system for remotely controlling an ambient temperature in a structure, the system comprising:
a digital thermostat having one or more settings for controlling a temperature adjustment device, the digital thermostat equipped for wireless communication;
a wireless local area network (LAN) including a computing device accessible thereon; and
wherein the digital thermostat wirelessly communicates with the computing device via the wireless LAN to allow configuration of the one or more settings from the computing device.

19. The system of claim 18, further comprising a wide area network accessible via the computing device, the WAN including a web server hosting a thin client interface to allow remote configuration of the one or more settings.

20. The system of claim 19, further comprising a thin client computing device remotely located from the digital thermostat and operatively coupled to the web server through the WAN, the thin client device displaying a user interface permitting manipulation of the one or more settings of the thermostat such that the ambient temperature in the residential dwelling is remotely controlled.
